(19) United States
(12) Patent Application Publication
(10) Pub. No.: US 2012/0043211 A1
(43) Pub. Date: Feb. 23, 2012

(54) CAPILLARY ELECTROPHORESIS APPARATUS

(76) Inventors: Yasutaka Otsuka, Hitachinaka (JP); Toshiyuki Sakurai, Hitachinaka (JP); Tomohiro Shoji, Hitachinaka (JP); Takeshi Ohura, Hitachinaka (JP)

(21) Appl. No.: 13/263,958

(22) PCT Filed: Apr. 8, 2010
(86) PCT No.: PCT/JP2010/056358

§ 371 Date: Oct. 11, 2011

(30) Foreign Application Priority Data
Apr. 13, 2009 (JP) 2009-097252

(51) Int. Cl. G01N 27/447; C25B 15/02

(52) U.S. Cl. 204/602

(57) ABSTRACT

Provided is a capillary electrophoresis apparatus capable of avoiding electric discharge even when a conductive component is arranged near a cathode end of a capillary. The capillary electrophoresis apparatus of the present invention has a structure in which a spatial distance and a creeping distance between an electrode attached to the cathode end of the capillary and the conductive component are large even when the conductive component is arranged near the cathode end of the capillary. That is to say, the capillary electrode, which protrudes from a lower surface of the load header, penetrates through a space between the load header and an anti-evaporation film and further penetrates through a capillary hole formed on the anti-evaporation film to extend into a container. At least a portion exposed to the space between the load header and the anti-evaporation film of the capillary electrode is covered with an insulating member.

### TECHNICAL FIELD

The present invention relates to a capillary electrophoresis apparatus, which separates and analyzes a sample such as nucleic acid and protein by electrophoresis.

### BACKGROUND ART

In the capillary electrophoresis apparatus, a high voltage is applied to a capillary for performing the electrophoresis. Recently, the voltage to be applied becomes higher in order to speed up the electrophoresis. When a conductive component having potential difference is present near a cathode end of the capillary, there is possibility of occurrence of electric discharge.

Then, the conventional capillary electrophoresis apparatus is designed so as not to arrange the conductive component near the cathode end of the capillary in order to avoid the electric discharge.

### PRIOR ART DOCUMENT

### Patent Document

Patent Document 1: Japanese Patent Application Laid-Open No. 2000-346828

### DISCLOSURE OF THE INVENTION

### Problem to be Solved by the Invention

Recently, it is desired to further miniaturize the capillary electrophoresis apparatus. When the apparatus is miniaturized, the cathode end of the capillary and the conductive component are inevitably arranged so as to be close to each other. Therefore, the possibility of the occurrence of the electric discharge increases.

The inventor of the present application focuses on the fact that the possibility of the occurrence of the electric discharge depends on a spatial distance and a creeping distance between an exposed portion of an electrode attached to the cathode end of the capillary and the conductive component. Then, the inventor of the present application considers that it is possible to prevent the electric discharge when the spatial distance and the creeping distance are large even when the conductive component is arranged near the cathode end of the capillary.

An object of the present invention is to provide the capillary electrophoresis apparatus capable of avoiding the electric discharge even when the conductive component having the potential difference is arranged near the cathode end of the capillary.

### Means to Solve the Problem

The present invention relates to a capillary electrophoresis apparatus, including: one or a plurality of capillaries; a load header including a capillary electrode through which the capillary penetrates; a power source, which applies a voltage to the capillary electrode; a constant temperature reservoir, which maintains an ambient temperature of the capillary constant; an optical system, which irradiates a sample separated by electrophoresis in the capillary with excitation light to detect fluorescence from the sample; a solution storage unit including a container in which the sample or electrolytic solution is contained and an anti-evaporation film to cover the container; and an auto sampler, which conveys the solution storage unit.

For example, the capillary electrode, which protrudes from a lower surface of the load header, penetrates through a space between the load header and the anti-evaporation film and further penetrates through a capillary hole formed on the anti-evaporation film to extend into the container. At least a portion exposed to the space between the load header and the anti-evaporation film of the capillary electrode is covered with an insulating member. Even when the conductive component is arranged near the cathode end of the capillary, the spatial distance and the creeping distance from the electrode attached to the cathode end of the capillary to the conductive component are large.

### Effects of the Invention

The present invention is capable of avoiding the electric discharge even when the conductive component is arranged near the cathode end of the capillary.

### BRIEF DESCRIPTION OF THE DRAWINGS

FIG. 1 is a view of an outline of an example of a capillary electrophoresis apparatus.

FIG. 2A is a view of a capillary, a load header, and a solution storage unit in the example of the capillary electrophoresis apparatus.

FIG. 2B is a view of a state in which the capillary, the load header, and the solution storage unit are assembled in the example of the capillary electrophoresis apparatus.

FIG. 3A is a cross-sectional view of the capillary, the load header, and the solution storage unit in the capillary electrophoresis apparatus.

FIG. 3B is an enlarged cross-sectional view of a part of the load header and the solution storage unit in the capillary electrophoresis apparatus.

FIG. 4A is a cross-sectional view of a first example of an electric discharge preventing mechanism in the capillary electrophoresis apparatus.

FIG. 4B is an enlarged cross-sectional view of a part of the first example of the electric discharge preventing mechanism in the capillary electrophoresis apparatus.

FIG. 5A is a view of an example of an anti-evaporation film in the capillary electrophoresis apparatus.

FIG. 5B is a perspective view of the example of the anti-evaporation film in the capillary electrophoresis apparatus.

FIG. 6A is a view of an example of the anti-evaporation film in the capillary electrophoresis apparatus.

FIG. 6B is a perspective view of the example of the anti-evaporation film in the capillary electrophoresis apparatus.

FIG. 7A is a cross-sectional view of a second example of the electric discharge preventing mechanism in the capillary electrophoresis apparatus.

FIG. 7B is an enlarged cross-sectional view of a part of the second example of the electric discharge preventing mechanism in the capillary electrophoresis apparatus.

FIG. 8A is a cross-sectional view of a third example of the electric discharge preventing mechanism in the capillary electrophoresis apparatus.

FIG. 8B is an enlarged cross-sectional view of a part of the third example of the electric discharge preventing mechanism in the capillary electrophoresis apparatus.

FIG. 9A is a cross-sectional view of a fourth example of the electric discharge preventing mechanism in the capillary electrophoresis apparatus.

FIG. 9B is an enlarged cross-sectional view of a part of the fourth example of the electric discharge preventing mechanism in the capillary electrophoresis apparatus.

### DESCRIPTION OF REFERENCE NUMERAL

101 . . . capillary
102 . . . capillary array
103 . . . pump mechanism
104 . . . optical system
105 . . . high-voltage power source
106 . . . constant temperature reservoir
107 . . . auto sampler
108 . . . syringe
109 . . . block
110 . . . check valve
111 . . . polymer container
112 . . . anode buffer container
113 . . . anode electrode
114 . . . cathode electrode
115 . . . load header
116 . . . reference base
117 . . . capillary head
118 . . . capillary cathode end
119 . . . cooling fan
120 . . . capillary electrode
200 . . . anti-evaporation film
201 . . . main body
202 . . . capillary hole
203 . . . lower-side projection
204 . . . sealing unit
205, 207 . . . projection
210 . . . solution storage unit (solution tray)
301 . . . conductive material around capillary
401 . . . concave portion
402 . . . cover portion
403 . . . concave portion
404 . . . cover member
405 . . . welding or bonding
406 . . . coating

### BEST MODE FOR CARRYING OUT THE INVENTION

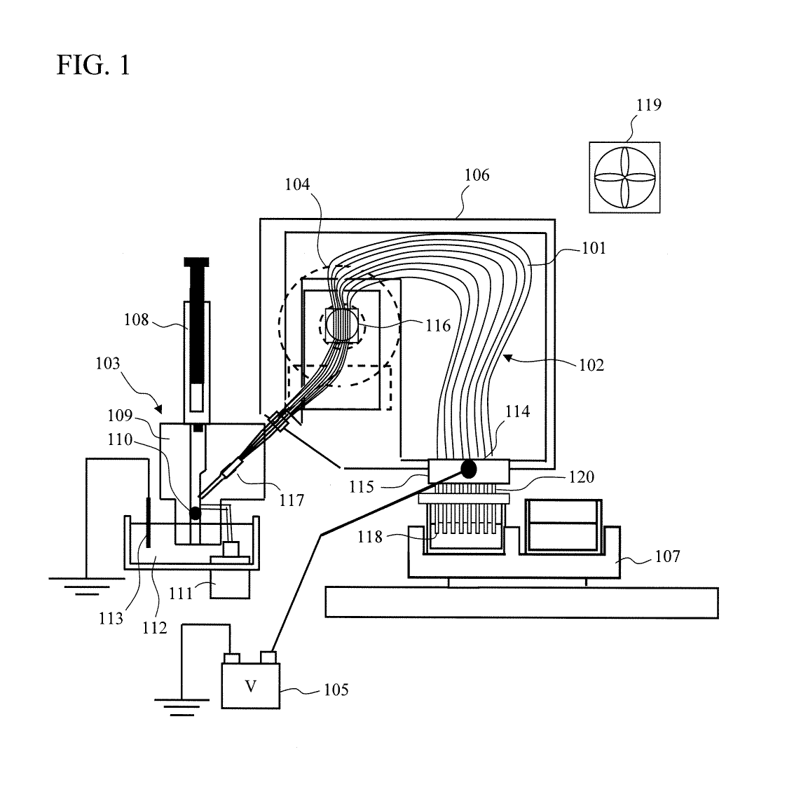

FIG. 1 illustrates an outline of one example of a capillary electrophoresis apparatus. The capillary electrophoresis apparatus of this example has a capillary array 102 including one or a plurality of capillaries 101, a pump mechanism 103 for injecting a polymer into the capillary 101, an optical system 104 for irradiating a sample in the capillary 101 with light to detect fluorescence of the sample, a high-voltage power source 105 for applying a high voltage to the capillary 101, a constant temperature reservoir 106 for maintaining a temperature of the capillary 101 constant, and an auto sampler 107 for conveying a container in which the sample, solution and the like are contained.

The capillary 101 is a replaceable member, which is replaced when a method of measurement is changed or when the capillary 101 is broken or deteriorated in quality. The capillary 101 is composed of a glass tube, of which inner diameter is from tens of microns to hundreds of microns and of which outer diameter is hundreds of microns, and a surface thereof is coated with polyimide. The capillary 101 is filled with a separation medium for giving difference in electrophoretic velocity at the time of electrophoresis. Although there are both of a liquid separation medium and a nonliquid separation medium as the separation medium, a liquid polymer is used in this embodiment.

A capillary head 117 is provided on one end of the capillary 101 and a capillary cathode end 118 is formed on the other end thereof. The capillary head 117 is obtained by binding the ends of the capillaries 101 and has a function to connect the pump mechanism 103 and the capillary 101 to each other. The capillary cathode end 118 is brought into contact with the sample, the solution and the like. The capillary 101 is fixed by a load header 115 on a side of the capillary cathode end. A cathode electrode 114 and a metallic hollow capillary electrode 120 are attached to the load header 115. There is an electrical connection between the cathode electrode 114 and the capillary electrode 120. The capillary cathode end 118 penetrates through the capillary electrode 120 to protrude from a tip thereof.

The optical system 104 is composed of an irradiation system and a detection system. The optical system 104 has a function to irradiate a part of the capillary 101 of which polyimide coating is removed, that is to say, a detection part with excitation light. The detection system has a function to detect the fluorescence from the sample in the detection part of the capillary 101. The sample is analyzed by light detected by the detection system.

The pump mechanism 103 has a syringe 108, a block 109, a check valve 110, a polymer container 111, and an anode buffer container 112. The capillary head 117 is connected to the block 109, and according to this, the capillary 101 and a flow path in the block 109 are connected to each other. The capillary 101 is filled or refilled with the polymer in the polymer container 111 through the flow path in the block 109 by operation of the syringe 108. The capillary 101 is refilled with the polymer for each measurement in order to improve performance of the measurement.

An anode electrode 113 is arranged in the anode buffer container 112. The high-voltage power source 105 applies the high voltage between the anode electrode 113 and the cathode electrode 114.

The constant temperature reservoir 106 of this example is a sandwich type by a rubber heater. That is to say, the capillary array 102 is hold in a planar manner between temperature controlling plates to which a heat insulating material and a heater are attached to maintain a temperature of the capillary to be constant. A temperature sensor for feedback is attached to the temperature controlling plate. Meanwhile, an air constant temperature reservoir may be used in place of the constant temperature reservoir 106 of this example. Also, it is possible to fix the capillary array 102 to a desired position of the optical system 104 by a reference base 116 provided on the capillary array 102. Also, it is possible to arrange the capillary cathode end 118 and the capillary electrode 120 on a desired position by fixing the load header 115 of the capillary array to the constant temperature reservoir.

The auto sampler 107 is provided with three electric motors and a linear guide for moving a moving stage and is capable of moving the moving state in triaxial directions, that is to say, a vertical direction, a horizontal direction, and a depth direction. The moving stage may convey a buffer container, a cleaning container, a waste solution container, and a sample plate to the capillary cathode end 118 as needed.

The capillary electrophoresis apparatus is provided with a cooling fan 119. A heating element such as the high-voltage power source 105 is provided in the apparatus. Then, the cooling fan 119 may generate circulation of air in the apparatus, thereby inhibiting local increase in temperature.

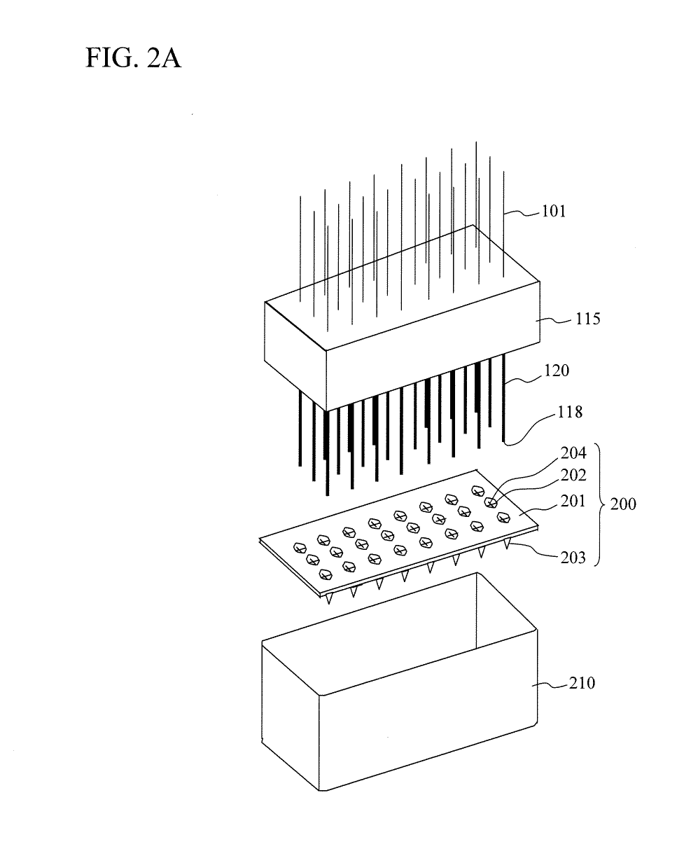

An example of a solution storage unit used by the capillary electrophoresis apparatus is described with reference to FIGS. 2A and 2B. As illustrated in FIG. 2A, the solution storage unit of this example has a container (solution tray) 210 and an anti-evaporation film 200. The capillary electrode 120 being a tube-shaped member is attached to the load header 115. The capillary 101 penetrates through the capillary electrode 120 and a tip end of the capillary, that is to say, the capillary cathode end 118 is exposed from a lower end of the capillary electrode 120. In this manner, it is possible to apply the voltage to the polymer in the capillary 101 through the capillary electrode 120.

The anti-evaporation film 200 has a main body 201, a capillary hole 202, and a lower-side projection 203. A sealing unit 204 integrally formed with the main body 201 is provided in an opening of the capillary hole 202. The sealing unit 204 is composed of a thin film of which center is cut in a cross-shape. The capillary electrode 120 penetrates through the capillary hole 202. The sealing unit 204 adheres around the capillary electrode 120, and according to this, evaporation of the solution stored in the container 210 from a gap between the capillary electrode 120 and the capillary hole 202 is prevented.

The load header 115 is composed of a resin material with a high electric insulation property and the container 210 and the anti-evaporation film 200 also are composed of the resin material with the high electric insulation property.

FIG. 2B illustrates a state in which the capillary 101, the load header 115, the container 210, and the anti-evaporation film 200 are assembled. The anti-evaporation film 200 is attached on the container 210. The capillary 101 is inserted into the capillary hole 202 of the anti-evaporation film 200. When conveying the solution storage unit by the auto sampler 107, relative misalignment in a perpendicular direction may occur between the load header 115 and the anti-evaporation film 200. Then, in this example, a clearance is generated between the load header 115 and the anti-evaporation film 200 as illustrated. Therefore, even when the relative misalignment occurs between the load header 115 and the anti-evaporation film 200, it is possible to absorb the same by the clearance therebetween. When the clearance is not generated between the load header 115 and the anti-evaporation film 200, if the relative misalignment in the perpendicular direction occurs between the load header 115 and the anti-evaporation film 200, the container 210 and the auto sampler 107 are subjected to an excessive load. This does not occur in this example.

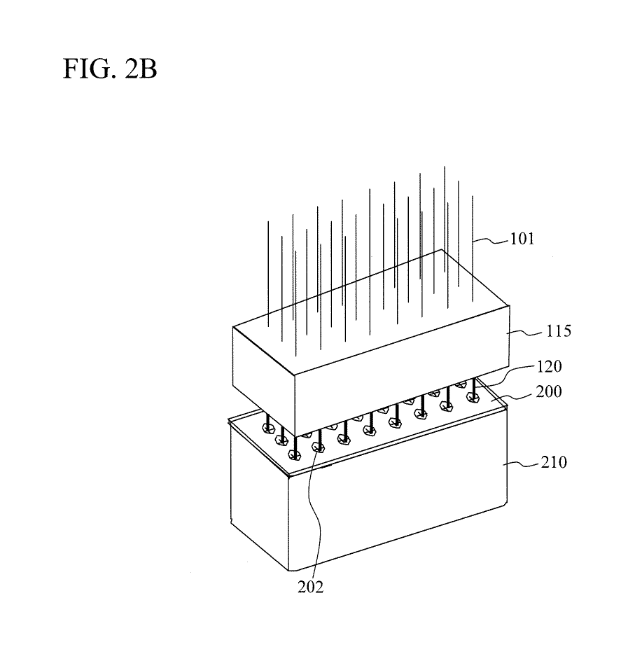

An electric discharge phenomenon in the capillary electrophoresis apparatus is described with reference to FIGS. 3A and 3B. Suppose that there is a conductive material 301 around an assembly of the load header 115 and the solution storage unit as illustrated in FIG. 3A. The conductive material 301 may be a shielding component for shielding an electromagnetic wave or a metallic frame of the constant temperature reservoir 106. Suppose that, in a space between the capillary electrode 120 and the conductive material 301, there is no obstacle between them. The electric discharge occurring in the space between the capillary electrode 120 and the conductive material 301 depends on a spatial distance and a creeping distance therebetween.

The spatial distance and the creeping distance are described with reference to FIG. 3B. The spatial distance indicated by a solid arrow is the shortest distance between an exposed portion of the capillary electrode 120 and the conductive material 301 in the space. On the other hand, the creeping distance indicated by a broken arrow is the shortest distance along a surface of an insulator between the exposed portion of the capillary electrode 120 and the conductive material 301 in the space. However, the spatial distance and the creeping distance are measured along the same route in the space in which the insulator is not present. In order to avoid occurrence of the electric discharge between the capillary electrode 120 and the conductive material 301, the spatial distance and the creeping distance should be larger than a predetermined value. That is to say, even when the conductive material 301 is arranged near the exposed portion of the capillary electrode 120, the occurrence of the electric discharge may be avoided if the spatial distance and the creeping distance are larger than a predetermined threshold. The predetermined threshold differs for each applied voltage and further differs for each environment in which the capillary electrophoresis apparatus is installed. Therefore, the predetermined threshold may be obtained only by individual actual measurement. In the capillary electrophoresis apparatus, the voltage to be applied to the capillary electrode 120 is several kV in preliminary electrophoresis and tens of kV in main electrophoresis, for example. Therefore, the voltage may be actually applied to allow the electric discharge to occur.

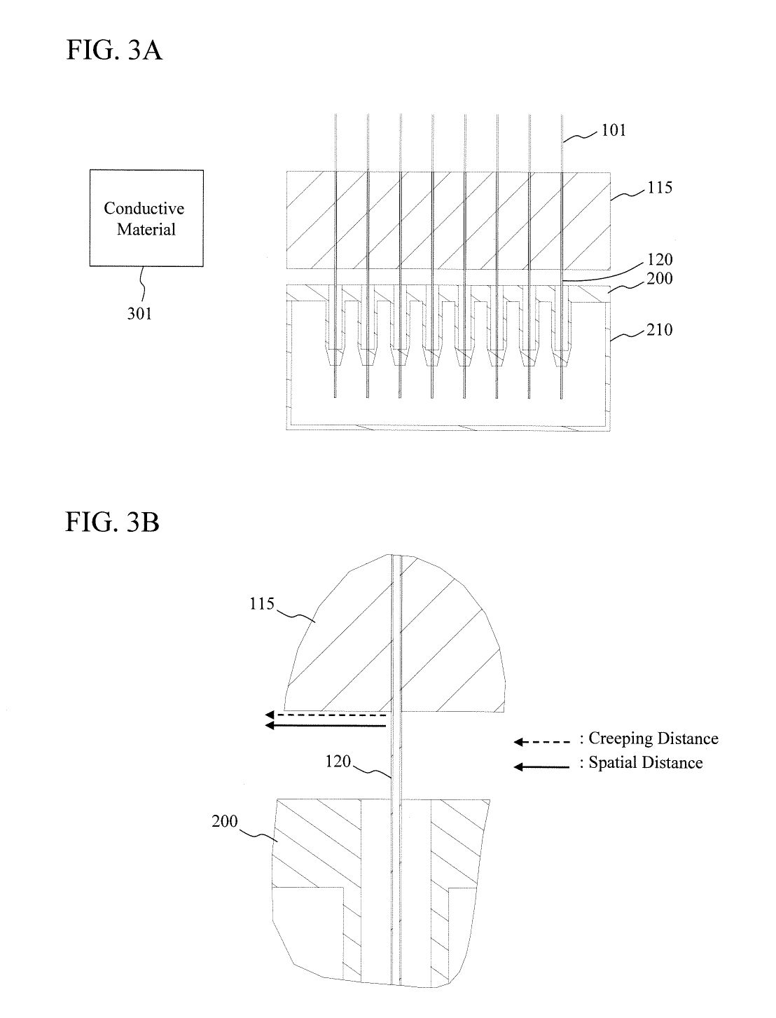

A first example of an electric discharge preventing mechanism in the capillary electrophoresis apparatus is described with reference to FIGS. 4A and 4B. Suppose that there is the conductive material 301 around the assembly of the load header 115 and the solution storage unit as illustrated in FIG. 4A. Suppose that, in the space between the capillary electrode 120 and the conductive material 301, there is no obstacle between them.

As illustrated in FIG. 4B, the load header 115 of this example has a plurality of concave portions 401 on a lower surface thereof and a projection-shaped cover portion 402 is formed in the concave portion 401. The capillary electrode 120 penetrates through a hole of the cover portion 402. On the other hand, the capillary hole 202 through which the capillary electrode 120 penetrates is provided on the anti-evaporation film 200. A cylindrical projection 205 is provided on an upper end of the capillary hole 202. An outer diameter of the cylindrical projection 205 of the anti-evaporation film 200 is smaller than an inner diameter of the concave portion 401 of the load header 115. At least a part of the cylindrical projection 205 is arranged in the concave portion 401 of the load header 115.

The solid arrow indicates the route along which the spatial distance between the exposed portion of the capillary electrode 120 and the conductive material 301 is measured and the broken arrow indicates the route along which the creeping distance between the exposed portion of the capillary electrode 120 and the conductive material 301 is measured. First, the spatial distance is described. The capillary electrode 120 protrudes from a lower end of the cover portion 402 of the load header 115. Therefore, a position A on an upper end of the exposed portion of the capillary electrode 120 is the closest to the conductive material 301. Then, a linear distance measured along the route from the position A on the upper end of the exposed portion of the capillary electrode 120 through an inner edge B and an outer edge C of the cylindrical projection 205 of the anti-evaporation film 200, an edge D of the concave portion 401 of the load header 115, and the lower surface of the load header 115 is the spatial distance. The spatial distance in the capillary electrophoresis apparatus of this example is sufficiently longer than the spatial distance in the capillary electrophoresis apparatus illustrated in FIG. 3B.

Next, the creeping distance is described. The linear distance measured along the route from the position A on the upper end of the exposed portion of the capillary electrode 120 through an edge E on an inner side of a bottom of the concave portion 401 of the load header 115, an edge F on an outer side of the bottom of the concave portion 401, the edge D of the concave portion 401 of the load header 115, and the lower surface of the load header 115 is the creeping distance. The creeping distance in the capillary electrophoresis apparatus of this example is sufficiently longer than the creeping distance in the capillary electrophoresis apparatus illustrated in FIG. 3B.

In this manner, the spatial distance and the creeping distance in the capillary electrophoresis apparatus of this example are longer than the spatial distance and the creeping distance in the capillary electrophoresis apparatus illustrated in FIG. 3B, so that the electric discharge between the exposed portion of the capillary electrode 120 and the conductive material 301 does not easily occur. Therefore, in the capillary electrophoresis apparatus of this example, a position of the assembly of the load header and the solution storage unit may be set so as to be closer to the conductive material 301. Therefore, miniaturization of the capillary electrophoresis apparatus may be realized.

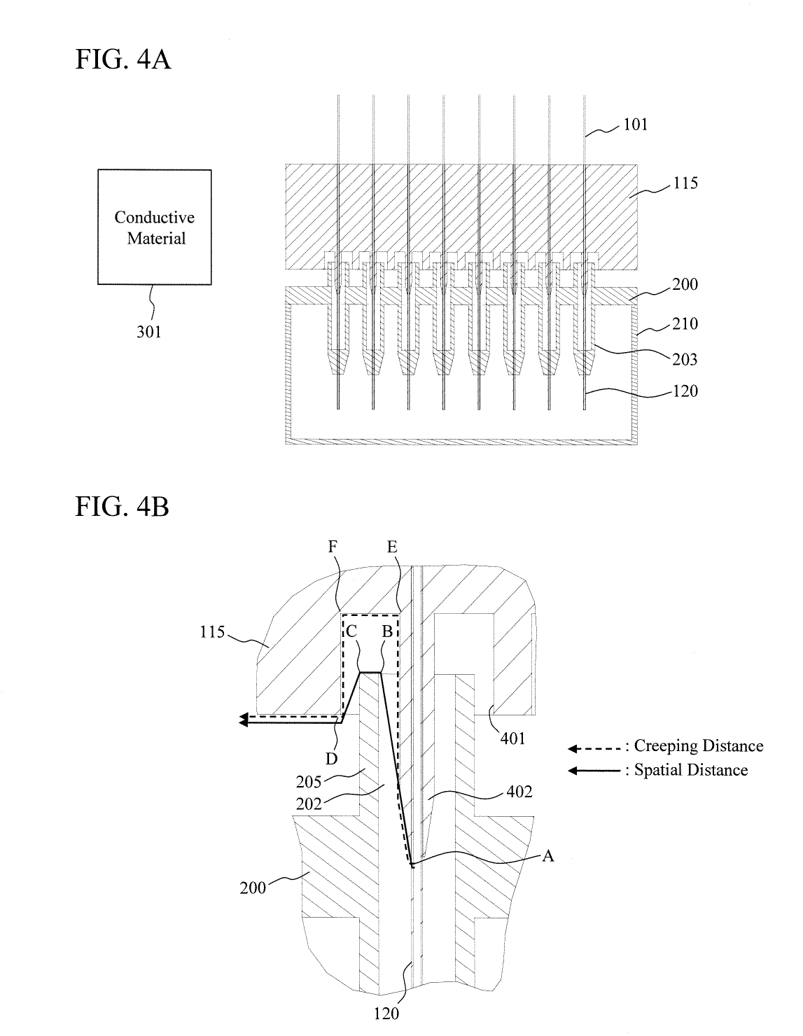

FIGS. 5A and 5B illustrate a first example of the anti-evaporation film. The anti-evaporation film 200 of this example has a plate-shaped main body 201, the capillary holes 202, the lower-side projection 203, and the cylindrical projection 205. Each of the capillary holes 202 is enclosed by one cylindrical projection 205. Therefore, the number of the cylindrical projections 205 is the same as that of the capillary holes 202.

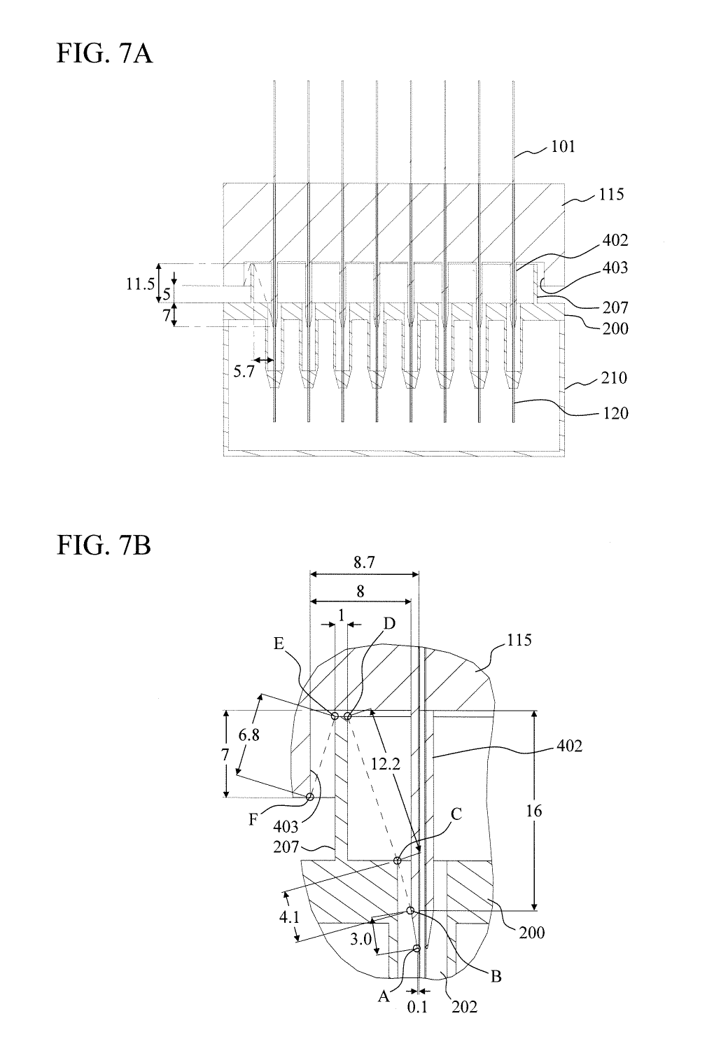

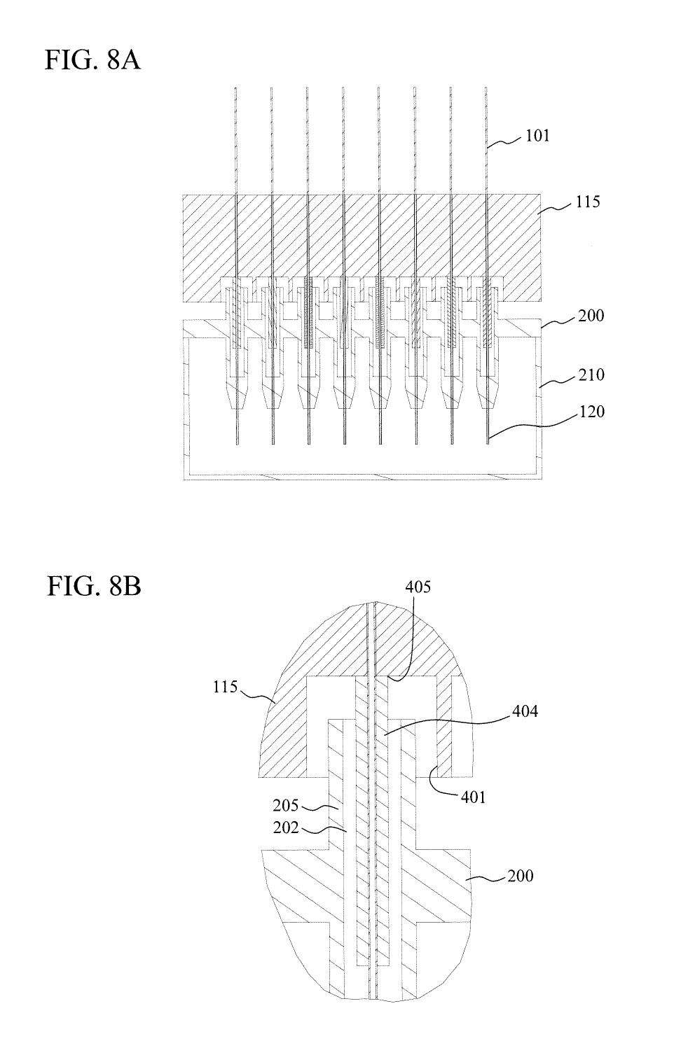

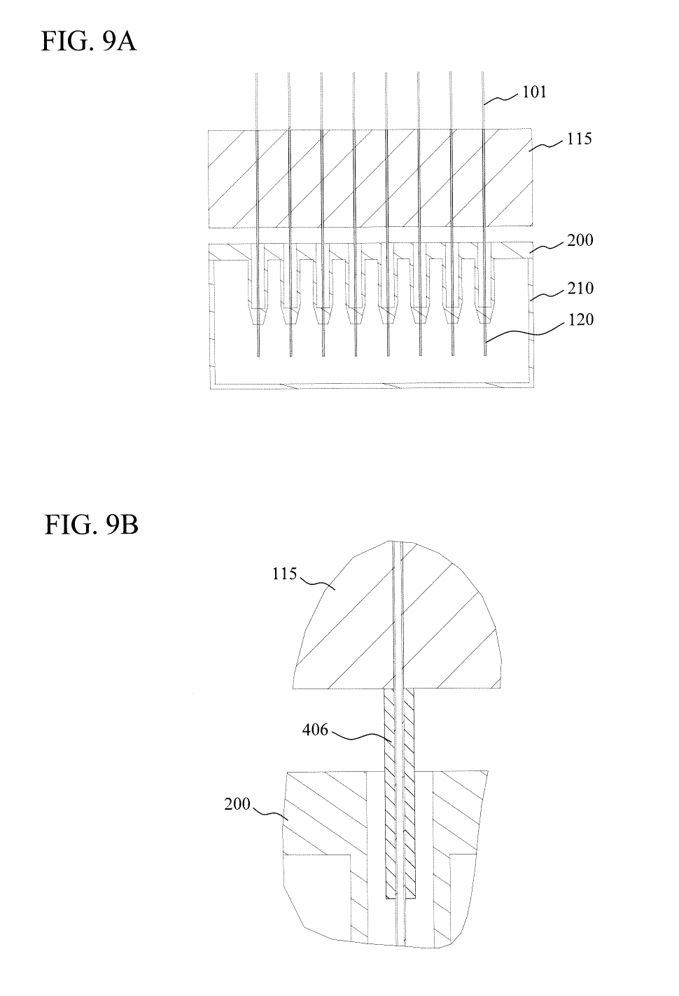

Although the anti-evaporation film of this example is used in the first example of the electric discharge preventing mechanism illustrated in FIGS. 4A and 4B and a third example of the electric discharge preventing mechanism illustrated in FIGS. 8A and 8B, this may also be used in a second example of the electric discharge preventing mechanism illustrated in FIGS. 7A and 7B. Further, the anti-evaporation film of this example may also be used in a fourth example of the electric discharge preventing mechanism illustrated in FIGS. 9A and 9B.

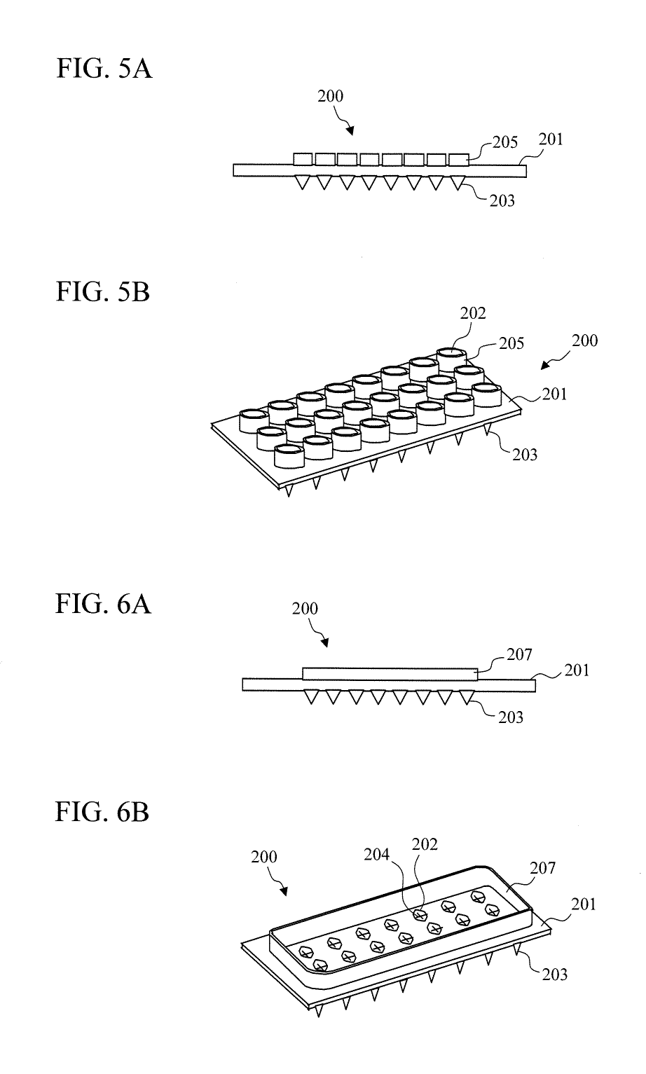

FIGS. 6A and 6B illustrate still another example of the anti-evaporation film. The anti-evaporation film 200 of this example has the plate-shaped main body 201, the capillary hole 202, the lower-side projection 203, and a cylindrical projection 207. The sealing unit 204 integrally formed with the main body 201 is provided in the opening of the capillary hole 202. The sealing unit 204 is composed of the thin film of which center is cut in the cross-shape. The projection 207 may be integrally formed with the main body 201. All the capillary holes 202 are enclosed by one cylindrical projection 207. Therefore, one cylindrical projection 207 is provided in this example.

Although the anti-evaporation film of this example is used in the second example of the electric discharge preventing mechanism illustrated in FIGS. 7A and 7B, this may also be used in the first example of the electric discharge preventing mechanism illustrated in FIGS. 4A and 4B and the third example of the electric discharge preventing mechanism illustrated in FIGS. 8A and 8B. Further, the anti-evaporation film of this example may also be used in the fourth example of the electric discharge preventing mechanism illustrated in FIGS. 9A and 9B.

The second example of the electric discharge preventing mechanism in the capillary electrophoresis apparatus of this example is described with reference to FIGS. 7A and 7B. As illustrated in FIG. 7A, the load header 115 of this example has one concave portion 403 on the lower surface thereof and a plurality of projection-shaped cover portions 402 are formed in the concave portion 403. The capillary electrode 120 penetrates through the hole of the cover portion 402. On the other hand, a plurality of capillary holes 202 through each of which the capillary electrode 120 penetrates are provided on the anti-evaporation film 200. One cylindrical projection 207 formed so as to enclose all the capillary holes 202 is provided on the upper surface of the anti-evaporation film 200. At least a part of the cylindrical projection 207 of the anti-evaporation film 200 is arranged within the concave portion 403 of the load header 115.

An example of dimensions of the spatial distance and the creeping distance is described with reference to FIG. 7B. A thickness of the lower end of the projection-shaped cover portion 402 of the load header 115 is set to 0.1 mm, the dimension of a tapered portion of the cover portion 402, that is to say, the distance from a lower end A to an upper end B of the tapered portion is set to 3 mm, the distance from the upper end B of the tapered portion to an edge C of the capillary hole 202 of the anti-evaporation film 200 is set to 4.1 mm, the distance from the edge C of the capillary hole 202 of the anti-evaporation film 200 to an inner edge D of the cylindrical projection 207 is set to 12.2 mm, the thickness of the cylindrical projection 207, that is to say, the distance from the inner edge D to an outer edge E is set to 1 mm, and the distance from the outer edge E of the cylindrical projection 207 to an edge F of the concave portion 403 of the load header 115 is set to 6.8 mm. The spatial distance is 0.1+3+4.1+12.2+1+6.8=27.2 mm.

The distance from the upper end B of the tapered portion of the projection-shaped cover portion 402 of the load header 115 to a bottom of the concave portion 403 of the load header 115 is set to 16 mm, the dimension of the bottom of the concave portion 403 of the load header 115 is set to 8 mm, and a depth of the concave portion 403 of the load header 115 is set to 7 mm. The creeping distance is 0.1+3+16+8+7=34.1 mm. The distance from an inner wall of the concave portion 403 of the load header 115 to the capillary electrode 120 is set to 8.7 mm. In the capillary electrophoresis apparatus of this example, the spatial distance increases by 27.2−8.7=18.5 mm and the creeping distance increases by 34.1−8.7=25.4 mm as compared to the capillary electrophoresis apparatus in FIG. 3B.

The third example of the electric discharge preventing mechanism is described with reference to FIGS. 8A and 8B. The load header 115 of this example has a plurality of concave portions 401 on the lower surface thereof. A cover member 404 made of an insulating material is attached to each of the concave portions 401. The cover member 404 is formed as a member different from the load header 115 to be fixed to the concave portion 401 of the load header 115 by welding or bonding 405.

The capillary electrode 120 protrudes from a bottom surface of the concave portion 401 to penetrate through the hole of the cover member 404. The cover member 404 of this example corresponds to the projection-shaped cover portion 402 in the first example of the electric discharge preventing mechanism in FIG. 4B. In this manner, the spatial distance and the creeping distance are large in this example as in the example of the electric discharge preventing mechanism in FIG. 4B.

Meanwhile, although the concave portion 401 is formed for each capillary electrode 120 in the load header 115 of this example as illustrated in FIG. 8A, it is also possible to form one concave portion 403 on the load header 115 and provide one cylindrical projection 207 on the anti-evaporation film 200 so as to enclose all the capillary electrodes 120 as in the example illustrated in FIG. 7A.

The fourth example of the electric discharge preventing mechanism is described with reference to FIGS. 9A and 9B. The capillary electrophoresis apparatus of this example differs from the example in FIGS. 3A and 3B in that a coating 406 of the insulating material is attached to the capillary electrode 120. That is to say, the coating 406 of the insulating material is formed on a portion of the capillary electrode 120 protruding from the lower surface of the load header 115. The insulating material may be polyimide, for example. In this manner, the spatial distance and the creeping distance are large in this example as in the example in FIG. 4B.

Although the anti-evaporation film illustrated in FIG. 3A may be used as the anti-evaporation film 200, it is also possible to use the anti-evaporation film illustrated in FIGS. 4A and 4B, FIGS. 5A and 5B, and FIGS. 6A and 6B.

Although the examples of the present invention are described above, the present invention is not limited to the above-described examples and one skilled in the art will comprehend that various modifications may be made within the scope of the invention recited in claims.

1. A capillary electrophoresis apparatus, comprising: one or a plurality of capillaries; a load header including a capillary electrode through which the capillary penetrates; a power source, which applies a voltage to the capillary electrode; a constant temperature reservoir, which maintains an ambient temperature of the capillary constant; an optical system, which irradiates a sample separated by electrophoresis in the capillary with excitation light to detect fluorescence from the sample; a solution storage unit including a container in which the sample or electrolytic solution is contained and an anti-evaporation film to cover the container; and an auto sampler, which conveys the solution storage unit,
wherein the capillary electrode, which protrudes from a lower surface of the load header, penetrates through a space between the load header and the anti-evaporation film and further penetrates through a capillary hole formed on the anti-evaporation film to extend into the container, and
at least a portion exposed to the space between the load header and the anti-evaporation film of the capillary electrode is covered with an insulating member.

2. The capillary electrophoresis apparatus according to claim 1, wherein the insulating member extends into the capillary hole of the anti-evaporation film.

3. The capillary electrophoresis apparatus according to claim 1, wherein a cylindrical portion, which encloses the capillary hole, is formed on an upper surface of the anti-evaporation film.

4. The capillary electrophoresis apparatus according to claim 3, wherein the cylindrical portion is provided for each of capillary holes so as to enclose each of the capillary holes.

5. The capillary electrophoresis apparatus according to claim 3, wherein the cylindrical portion is provided so as to enclose all of capillary holes.

6. The capillary electrophoresis apparatus according to claim 1, wherein a concave portion is formed on the lower surface of the load header and the insulating member extends downward from a bottom of the concave portion.

7. The capillary electrophoresis apparatus according to claim 6, wherein the concave portion is formed for each of capillary electrodes such that each of the capillary electrodes is arranged in the concave portion.

8. The capillary electrophoresis apparatus according to claim 6, wherein the concave portion is formed such that all of capillary electrodes are arranged in the concave portion.

9. The capillary electrophoresis apparatus according to claim 1, wherein the insulating member is composed as a part of the load header, which protrudes from the lower surface of the load header.

10. The capillary electrophoresis apparatus according to claim 1, wherein the insulating member is composed of a member different from the load header attached to the lower surface of the load header.

11. The capillary electrophoresis apparatus according to claim 1, wherein the insulating member is composed of a coating of the capillary electrode.

12. A load header used in a capillary electrophoresis apparatus including one or a plurality of capillaries; a power source, which applies a voltage to both ends of the capillary; a constant temperature reservoir, which maintains an ambient temperature of the capillary constant; an optical system, which irradiates a sample separated by electrophoresis in the capillary with excitation light to detect fluorescence from the sample; a solution storage unit including a container in which the sample or electrolytic solution is contained and an anti-evaporation film to cover the container; and an auto sampler, which conveys the solution storage unit, the load header comprising: a capillary electrode through which the capillary penetrates, wherein at least a portion exposed to a space between the load header and the anti-evaporation film of the capillary electrode is covered with an insulating member.

13. The load header according to claim 12, wherein a concave portion is formed on a lower surface of the load header and the insulating member protrudes downward from a bottom of the concave portion.

14. The load header according to claim 13, wherein the concave portion is formed for each of capillary electrodes such that each of the capillary electrodes is arranged in the concave portion.

15. The load header according to claim 13, wherein the concave portion is formed such that all of capillary electrodes are arranged in the concave portion.

16. The load header according to claim 12, wherein the insulating member is composed as a part of the load header, which protrudes from a lower surface of the load header.

17. The load header according to claim 1, wherein the insulating member is composed of a member different from the load header.

18. A solution storage unit used in a capillary electrophoresis apparatus including one or a plurality of capillaries; a load header including a capillary electrode through which the capillary penetrates; a power source, which applies a voltage to the capillary electrode; a constant temperature reservoir, which maintains an ambient temperature of the capillary constant; an optical system, which irradiates a sample separated by electrophoresis in the capillary with excitation light to detect fluorescence from the sample; and an auto sampler, the solution storage unit comprising: a container in which the sample or electrolytic solution is contained and an anti-evaporation film to cover the container, wherein the anti-evaporation film includes a plate-shaped main body, a capillary hole through which the capillary penetrates, and a cylindrical projection, which encloses the capillary hole.

19. The solution storage unit according to claim 18, wherein the cylindrical portion is provided for each of capillary holes so as to enclose each of the capillary holes.

20. The solution storage unit according to claim 18, wherein the cylindrical portion is provided so as to enclose all capillary holes.
